(19) United States
(12) Patent Application Publication
(10) Pub. No.: US 2003/0007223 A1
(43) Pub. Date: Jan. 9, 2003

(54) Receiver for receiving optical signals

(75) Inventor: Thomas Pfeiffer, Stuttgart (DE)

Correspondence Address: SUGHRUE MION, PLLC, 2100 PENNSYLVANIA AVENUE, N.W., WASHINGTON, DC, 20037, US

(73) Assignee: ALCATEL

(21) Appl. No.: 10/186,918

(22) Filed: Jul. 2, 2002

(30) Foreign Application Priority Data
Jul. 3, 2001 (DE) 10132124.4

(51) Int. Cl. H04B 10/00; H04B 10/06

(52) U.S. Cl. 359/189; 359/161

(57) ABSTRACT

The object of the invention is to provide an optical receiver for an OCDM system which has improved compensating characteristics. The receiver according to the invention comprises two filters which are fed by received optical signals and have different pass frequencies. One of the filters is matched to the optical signals to be received. The other filter is not matched to the optical signals to be received. The optical signals passed by the other filter serve as compensation signals that are used to compensate for disturbances in the desired optical signals passed by the first-mentioned filter. As a result of the symmetrical design of the receiver with two filters, two optical-to-electrical converters, and a comparator, optimized compensation is provided and the receiver can be used in a wide frequency range.

### TECHNICAL FIELD

This invention relates to a receiver for receiving optical signals.

The invention is based on a priority application DE 101 32 124.4 which is hereby incorporated by reference.

### BACKGROUND OF THE INVENTION

EP 0 883 254 A2 discloses a receiver for receiving optical signals from a fiber-optic transmission network for transmitting encoded, multiplexed optical signals. The receiver comprises in particular a means for detecting the optical signals to be received, e.g., a Fabry-Perot filter, and a processing means (e.g., two optical-to-electrical converters and an operational amplifier) for compensating for disturbances in the detected optical signals by combining the detected optical signals with compensation signals. The receiver is characterized in that it comprises a means, e.g., the above Fabry-Perot filter, which is adapted to transmit optical signals to be received and to reflect optical signals not to be received, and that a further means, e.g., an optical coupler, is provided for deriving the compensation signals from at least part of the reflected optical signals and then feeding them to the processing means. The receiver has the advantage that no or only a minimal component of the signal to be received is contained in the compensation signal, so that the signal to be received will not or only negligibly affect the degree of compensation when being combined with the detected signal. A disadvantage is that the Fabry-Perot filter introduces asymmetry into the receiver setup, thus degrading the common mode rejection ratio (CMRR), particularly at high electrical modulation frequencies.

### SUMMARY OF THE INVENTION

The invention has for its object to provide an optical receiver which has better compensating characteristics.

This object is attained by a receiver for receiving optical signals from a fiber-optic transmission network for transmitting encoded optical signals, particularly OCDM signals, comprising a first filter for detecting the optical signals to be received and a processing means for compensating for disturbances in the detected optical signals by combining the detected optical signals with compensation signals, wherein the first filter is adapted to transmit optical signals to be received, and wherein a coupling device is provided for transferring a portion of the power of the received optical signals to the first filter and another portion of the power of the received optical signals to a second filter, the two filters being of the same type but having different pass frequencies, and the compensation signals being derived from the output signals of the second filter. The receiver according to the invention comprises two filters which are fed by received optical signals and which have different pass frequencies. One of the filters is matched to the optical signals to be received. The other filter is not matched to the optical signals to be received. The optical signals passed by the other filter serve as compensation signals which are used to compensate for disturbances in the desired optical signals passed by the first-mentioned filter. As a result of the symmetrical design of the receiver with two filters, two optical-to-electrical converters, and a comparator, optimized compensation is provided and the receiver can be used in a wide frequency range. Particularly at high modulation frequencies, e.g., 5 GHz, a sufficient CMRR, e.g., −20 dB, is present.

The basic idea of the invention is to use a differential receiver in order to suppress crosstalk from unwanted channels by subtraction. To obtain practically identical modulation transfer functions (MTFs) of the two arms (complex modulation amplitude as a function of electrical frequency), optical filters which are functionally identical but have slightly different free spectral ranges (FSRs) are used in the two arms. As a result, the influences exerted by the optical filters on the MTFs of the two arms are approximately identical, so that the crosstalk suppression is optimized. The filters must not be exactly identical, because otherwise the desired signal would be suppressed as well.

### BRIEF DESCRIPTION OF THE DRAWINGS

An embodiment of the invention will now be explained with reference to the accompanying drawing, in which:

FIG. 1 is a block diagram of a receiver according to the invention; and

FIG. 2 is a CMRR diagram.

### BEST MODE FOR CARRYING OUT THE INVENTION

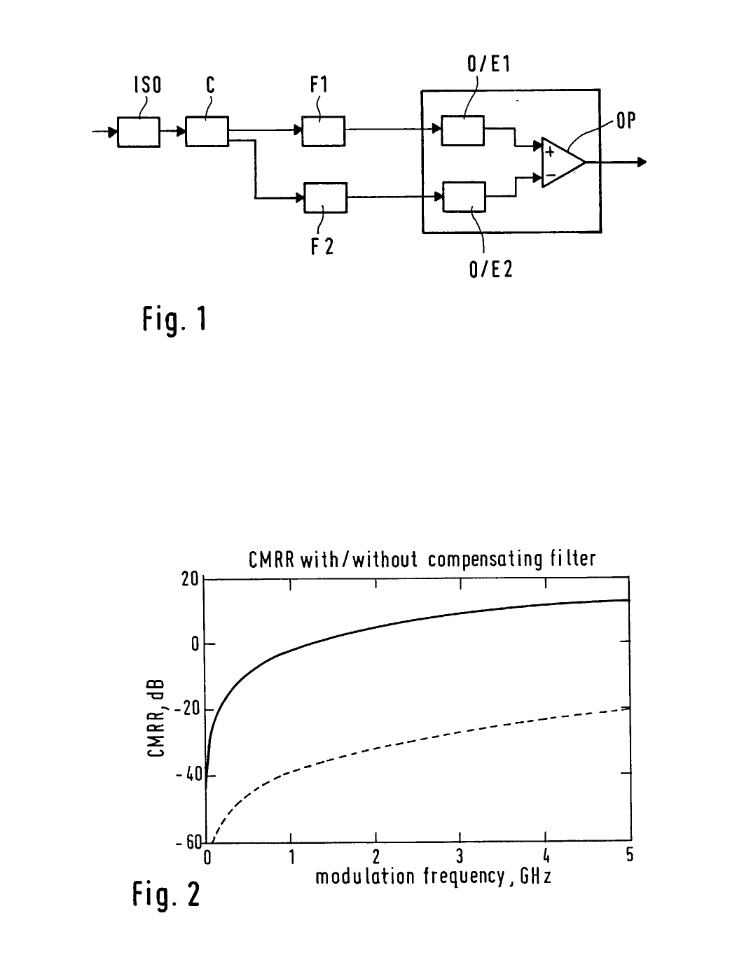

The embodiment will first be explained with the aid of FIG. 1. FIG. 1 shows a receiver according to the invention in block-diagram form. The receiver is used in an OCDM system; OCDM=optical code division multiplexing, sometimes also referred to as OCDMA=optical code division multiple access.

An OCDM system is, as a rule, configured as a multipoint-to-multipoint system with several transmitters and several receivers and is based on spectral encoding of broadband sources, but it may also be configured as a point-to-point, point-to-multipoint, or multipoint-to-point system. The broadband sources are light-emitting diodes (LEDs), for example. Each transmitter transmits optical signals which are encoded in at least one code, and each receiver receives optical signals which are encoded in at least one code. Each code represents an optical channel and is generated, for example, by using a passive optical filter. The optical signals are transmitted on the transmission network between transmitters and receivers in heterodyned form, for instance by using an optical combiner. Through the heterodyning of the signals, undesired coupling from individual channels to other channels may occur. This undesired coupling is referred to as crosstalk.

The receiver serves to suppress crosstalk from unwanted optical channels. A differential receiver is used.

The receiver comprises an isolator ISO, a coupling device C, two passive optical filters F1, F2, two optical-to-electrical converters O/E1, O/E2, and a comparator OP.

The coupling device C is implemented, for example, as a symmetrical or asymmetrical 3 dB optical coupler having two inputs and two outputs. The comparator OP is designed, for example, as an operational amplifier having a positive and a negative input. Each of the optical-to-electrical converters O/E1, O/E2 is designed as a photodiode, for example.

A first series combination is formed by optical isolator ISO, optical coupling device C, filter F1, optical-to-electrical converter O/E1, and the positive input of comparator OP. A second series combination is formed by optical coupling device C, filter F2, optical-to-electrical converter O/E2, and the negative input of comparator OP.

Filter F1 has an adjustable pass frequency and is implemented, for example, as a Fabry-Perot or Mach-Zehnder filter. Filter F2 has an adjustable pass frequency and is implemented, for example, as a Fabry-Perot or Mach-Zehnder filter.

Filter F1 is adjusted to pass the desired optical signals. It is thus matched, i.e., tuned, to the desired frequency. Filter F1 thus receives optical signals of a code that corresponds to an optical channel. The pass frequency, also referred to as FSR, is adjusted to 13.3 GHz, for example.

Filter F2 is adjusted to block the desired optical signals. Accordingly, it is not matched, i.e., mismatched or not tuned, to the desired frequency. Filter F2 is not matched to any other but the desired code or optical channel but has a pass frequency which lies between the channels being used. The pass frequency of filter F2 is adjusted to a value close to the pass frequency of filter F1, for instance to 11.1 GHz. Filter F2 thus filters optical crosstalk signals which are essentially also present in the optical signals filtered in filter F1. The filtered signals can therefore be used as compensation signals. After optical-to-electrical conversion, the signals filtered in filter F2 are subtracted in comparator OP from the signals filtered in filter F1, so that the desired signals are available at the output of the comparator OP with minimized and ideally canceled crosstalk components.

Filters F1 and F2 are of the same type. The crosstalk signals are thus subjected to the same delay and the same attenuation in both filters. Because of the symmetrical configuration, the compensation is optimized.

The embodiment will now be further explained with the aid of FIG. 2. FIG. 2 shows a CMRR diagram.

The degree of suppression is defined by the CMRR. The CMRR is determined by the difference of the complex transfer functions of the two arms of the receiver of FIG. 1. Because of the two arms and the comparator, the receiver is also called a differential receiver. The complex transfer functions comprise impacts of both optical and electrical elements such as couplers, filters, photodiodes, optical and electrical delay lines, attenuators, etc. If the complex transfer functions of the two receiver arms are very different, it may become impossible to improve the CMRR beyond certain limits, so that a required system performance cannot be achieved. A filter with an electrical frequency dependent transmission factor, if inserted into one arm of the receiver, will introduce asymmetry into the receiver setup, thus degrading the CMRR, particularly at high electrical modulation frequencies. If a filter of the some type is additionally inserted in the other arm of the receiver, the CMRR can be significantly improved. The two filters have different FSRs. The FSR of the filter in the other arm must not match any of the optical channels. The integrated transmission of the filter is then independent of the channel code.

A numerical example is shown in FIG. 2. The vertical axis represents the CMRR in dB, and the horizontal axis represents the modulation frequency in GHz. The upper curve shows a CMRR without compensating filter, and the lower, dashed curve shows a CMRR with compensating filter. The filter Fl of FIG. 1 is designed, for example, as a Mach-Zender filter with FSR=13.3 GHz. Without filter F2, the upper curve is obtained, with which a CMRR of −20 dB is reached only for modulation frequencies up to 130 MHz. Using a filter F2 implemented as a Fabry-Perot filter with FSR=11.1 GHz, the lower curve is obtained, with which a CMRR of −20 dB is reached for modulation frequencies up to 5 GHz. By means of a suitably mismatched filter F2, a substantial improvement in CMRR is thus achieved.

The pass frequencies of the filters are exemplary values. For filters F1 and F2, pass frequencies in the range of, e.g., 1 to 50 GHz can be adjusted. The adjusted pass frequencies of filters F1 and F2 do not differ by more than 30%, for example.

1. A receiver for receiving optical signals from a fiber-optic transmission network for transmitting encoded optical signals, particularly OCDM signals, comprising a first filter for detecting the optical signals to be received and a processing means for compensating for disturbances in the detected optical signals by combining the detected optical signals with compensation signals, wherein the first filter is adapted to transmit optical signals to be received, and wherein a coupling device is provided for transferring a portion of the power of the received optical signals to the first filter and another portion of the power of the received optical signals to a second filter, the two filters being of the same type but having different pass frequencies, and the compensation signals being derived from the output signals of the second filter.

2. A receiver as set forth in claim 1, wherein the processing means comprises a first and a second optical-to-electrical converter and a comparator, wherein the first filter, the first optical-to-electrical converter, and the positive input of the comparator are connected in series, and wherein the second filter, the second optical-to-electrical converter, and the negative input of the comparator are connected in series.

3. A receiver as set forth in claim 1, wherein the first filter is implemented as a Fabry-Perot or Mach-Zehnder filter, and wherein the second filter is implemented as a Fabry-Perot or Mach-Zehnder filter.

4. A receiver as set forth in claim 1, wherein the pass frequencies of both filters are adjustable.

5. A receiver as set forth in claim 4, wherein the pass frequencies of the two filters do not differ by more than 30% and lie in the range of 1 to 50 GHz.
